(19) United States
(12) Patent Application Publication
(10) Pub. No.: US 2018/0135786 A1
(43) Pub. Date: May 17, 2018

(54) COUPLING COLLAR AND DEVICE FOR COUPLING PIPES COMPRISING SUCH A COUPLING COLLAR

(71) Applicant: Zodiac Fluid Equipment, Soignolles En Brie (FR)

(72) Inventors: Patrick Bourbon, Andrezel (FR); David Cosoleto, Savigny-le-temple (FR); Nicolas Fraysse, Melun (FR); Denis Sindezingue, Chaumes-en-brie (FR)

(21) Appl. No.: 15/571,488

(22) PCT Filed: May 6, 2016
(86) PCT No.: PCT/FR2016/051070

§ 371 Date: Nov. 2, 2017

(30) Foreign Application Priority Data
May 5, 2015 (FR) 1553995

(51) Int. Cl. F16L 23/06; F16L 25/01

(52) U.S. Cl. CPC F16L 23/06; F16L 25/01

(57) ABSTRACT

The invention relates to a coupling collar (5) for sealingly coupling two pipes (2) comprising: a first shell (8) and a second shell (9), each having a first end (8a, 9a) and a second end (8b, 9b); a pipe-connection element (30, 31) in contact with one of the shells (8, 9) and comprising a first portion (30a, 31a) and a second portion (30b, 31b), electrically connected to the first portion (30b, 31b). The first shell (8) and/or the second shell (9) comprises a sheath-connection element (36, 37) comprising a contact tab (38, 39, 38a, 38b, 39a, 39b, 57, 58) extending into a space arranged between the first ends (8a, 9a) and/or the second ends of the first shell (8) and the second shell (9), when the coupling collar (5) is in closed position.

The invention relates to the field of devices for coupling of pipes, and more specifically it relates to a coupling collar for a coupling device comprising at least two shells which can connect two pipes, each having a free end, and designed in particular, but in a non-limiting manner, to be used in aircraft for the transport of fluids.

A coupling device of this type generally comprises a coupling collar in two parts, also known as shells or laws or half-shells, all of these terms designating the same elements. The shells are articulated relative to one another by one or more hinges. The coupling device can also comprise a sheath which is fitted in a sealed manner on the free ends of the pipes, also known as ferrules, to create continuity in the transport of the fluid. Preferably, the coupling collar is closed on the two ferrules and on the sheath in order to retain it in position.

A first function of the coupling collar is to ensure the assembly of the pipes and the fluid continuity when the shells are locked in order to keep the coupling collar closed by means of a system which can be released.

A second function of the coupling collar is to ensure the electrical continuity. In fact, for reasons of safety, and in particular when the fluid transported is flammable, typically in the case of a fuel, it is important to ensure the dissipation and passage of electrostatic charges or lightning in order to prevent the creation of an electric arc. More specifically, the electric arc is created between elements which are not in electrical contact, and therefore have different electrical potentials. Passage of the electric arc through the fluid can give rise to its combustion. The dissipation of dynamic charges, such as those which can circulate after lightning has struck the aircraft, must also be able to be dissipated rapidly.

Coupling devices of this type are designed such as to ensure strong electrical continuity between the two ferrules, the sheath, and the units which constitute the coupling collar itself.

Document EP 2 304 297 presents an example of a coupling device of this type. According to this example, the coupling device comprises a pair of metal shells articulated around a hinge, which close freely on the free end of two pipes, the ferrules, and on the sheath. Each shell has an inspection opening which allows an operator to check visually for the presence of the sheath when the collar is closed. Each shell also comprises a metallization wire which is bent such as to be in contact with the ferrule of each pipe, in order to ensure the electrical continuity between the two ferrules by means of each shell. The coupling device also comprises connection units made of metal, in order to connect the sheath and the shells electrically so as to put the sheath at the same potential as the shells. The connection units are all in the form of tabs, comprising an outer portion which is used for fitting on the corresponding shell, and a finger portion which extends in the inspection hole of the corresponding shell, in order to come into contact with the sheath.

Thus, electrical continuity is ensured: all the metal elements are connected electrically to one another.

However, the solutions put into place in this coupling device in order to ensure the electrical continuity are not satisfactory from the point of view of size. In particular, the connection units are fitted on the exterior of the shells at the hinge, such that the hinge must have dimensions which permit this fitting, and prevent interference with the parts of the hinge.

In addition, the finger portion which is inserted in the inspection hole conceals part of the sheath, whereas in principle the inspection hole specifically has the purpose of revealing the sheath.

In addition, the connection unit is in the form of an additional part of the coupling device, thus making the production and assembly more complex and therefore more costly.

Consequently, there is a need for a device for coupling of pipes which in particular overcomes the aforementioned disadvantages.

Thus, a first objective of the invention is to propose a coupling collar for a pipe coupling device which ensures the electrical continuity.

A second objective of the invention is to propose a coupling collar for a pipe coupling device which does not cause problems of interference with other parts of the coupling collar.

A third objective of the invention is to propose a coupling collar for a pipe coupling device which does not conceal the sheath.

A fourth objective of the invention is to propose a coupling collar for a pipe coupling device, the production costs of which are reduced.

According to a first aspect, the invention proposes a coupling collar to couple two pipes in a sealed manner, comprising:
at least one first shell and at least one second shell, each with a first end and a second end;
at least one connection-pipe element in contact with at least one of the shells, and comprising at least one first portion which is designed to be in electrical contact with one of the pipes when the coupling collar is in the closed position, and at least one second portion which is connected electrically to the first portion, and is designed to be in electrical contact with the other one of the pipes when the coupling collar is in the closed position, characterized in that the first shell and/or the second shell comprise(s) at least one connection-sheath element comprising at least one contact tab which extends in at least one space provided between the first ends and/or the second ends of the first shell and the second shell, when the coupling collar is in the closed position.

In various embodiments of the coupling collar according to the invention, use can optionally also be made of one and/or the other of the following arrangements:
the coupling collar comprises at least one contact tab which extends in the space between the first ends of the first shell and the second shell, and at least one contact tab which extends in the space between the second ends of the first shell and the second shell;
the connection-pipe element is in the form of a wire element in contact with an inner face of the first shell and/or the second shell, and comprises at least one intermediate portion connecting the first portion and the second portion electrically;
the connection-sheath element is formed by the intermediate portion of the connection-pipe element, the intermediate portion being bent in order to form at least the contact tab;
the connection-pipe element comprises two intermediate portions, each intermediate portion being bent in order to form at least one first tongue which extends in the space between the first ends of the first shell and of the second shell, and at least one second tongue which extends in the space between the second ends of the first shell and the second shell, when the coupling collar is in the closed position;
the coupling collar comprises an articulation device comprising at least one shaft on the first shell and at least one shaft on the second shell, at least one connection hinge connecting the shaft of the first shell and the shaft of the second shell;
the connection hinge comprises the contact tab which extends in the space between the first end of the first shell and the first end of the second shell;
the articulation device comprises a first shaft and a second shaft on the first shell, and a third shaft and a fourth shaft on the second shell;
the first shell and/or the second shell is/are provided with at least one inspection opening which is completely clear;
at least one of the surfaces of the first shell and/or the second shell is/are electrically conductive;
the coupling collar comprises a locking device which can be released, with a. locked state, in which the coupling collar is maintained in the closed position, and an unlocked state, in which the first shell and the second shell can pivot freely relative to one another;
the coupling collar additionally comprises a clasp which is articulated on the first shell or the second shell, the clasp comprising an attachment portion and at least one return tab, the clasp being able to adopt an initial open position, in which the attachment portion is spaced from the first shell, and respectively from the second shell, or a closed position, in which the attachment position is fastened on the second shell or the first shell respectively, and the clasp can be in the closed position only when the locking device is in the locked state, in which the return tab cooperates resiliently with the first shell or the second shell in order to apply a force on the clasp which tends to return. it to the initial open position;
the clasp goes from the closed position to the open position, and conversely, by rotation on the first shell or the second shell by an angle with a predetermined value;
the locking device comprises at least one hook articulated on the first shell or the second shell, the first hook having at least one spring blade which cooperates with the first shell or the second shell, and exerts a permanent constraint on the first hook which tends to retain it in a given stable position;
the locking device comprises at least one hook articulated on the first shell or the second shell respectively, the first hook comprising at least one opening for rotation around a first axis of articulation, the opening defining a first center, the first hook also comprising at least one notch for snapping onto at least the second shell or the first shell respectively;
the notch has a bottom which defines a second center, a first direction being defined as passing via the first center and the second center, and a second direction being defined as being perpendicular to the first direction, the notch also having a proximal edge in a third direction which is inclined relative to the second direction;
the third direction is inclined relative to the second direction by an angle of between 5° and 10°, and which is preferably equal to 7°.

According to a second. aspect, the invention proposes a coupling device in order to couple two pipes in sealed manner as well as the coupling collar and a sheath.

According to an additional characteristic in accordance with the invention, the contact tab is preferably in electrical contact on the sheath when the coupling collar is in the closed position.

According to a second aspect, the invention proposes piping designed to ensure the transport of a fluid, the piping comprising at least two pipes and the coupling device for coupling the pipes in a sealed manner.

It will be appreciated that the different characteristics, variants and/or embodiments of the present invention can be associated with one another according to various combinations, provided that they are not incompatible or mutually exclusive.

The present invention will be better understood, and other characteristics and advantages of it will become more apparent from reading the following detailed description comprising embodiments provided by way of illustration with reference to the appended figures, presented by way of non-limiting examples, which can be used to complete the understanding of the present invention and the description of its implementation, and, if applicable, to contribute to its definition, in which figures:

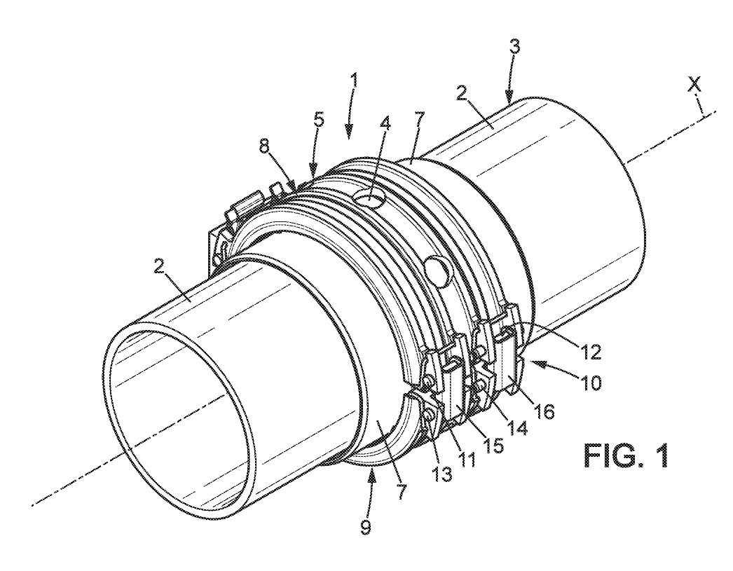

FIG. 1 is a three-dimensional three-quarter view of a coupling device comprising a coupling collar according to a first embodiment, assembled between two pipes;

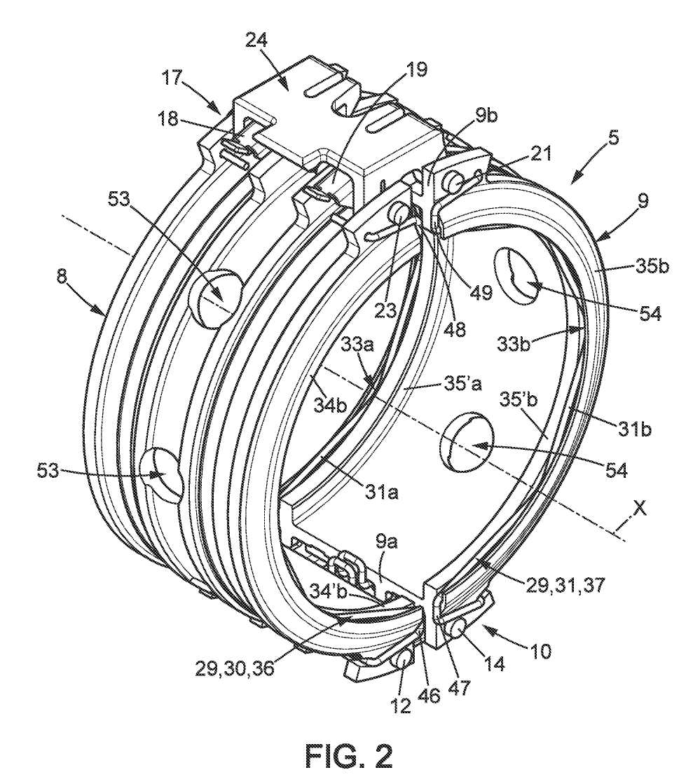

FIG. 2 is a three-dimensional three-quarter view of the coupling collar in FIG. 1 in a closed position;

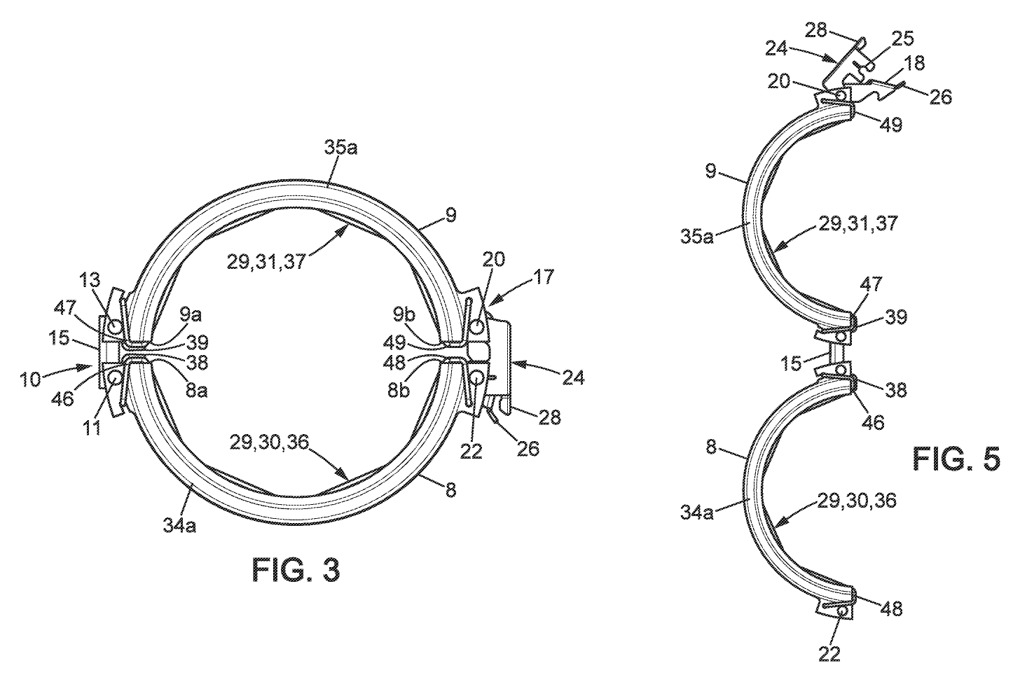

FIG. 3 is a front view of the coupling collar in FIG. 2;

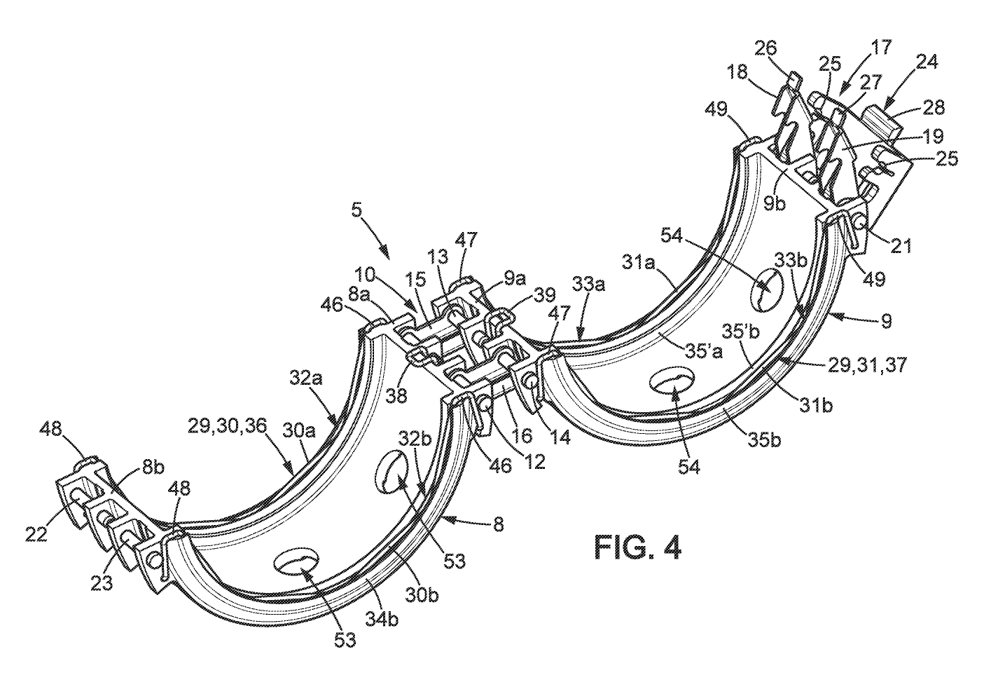

FIG. 4 is a view similar to FIG. 2, of the coupling collar, in an open position;

FIG. 5 is a front view of the coupling collar in FIG. 4;

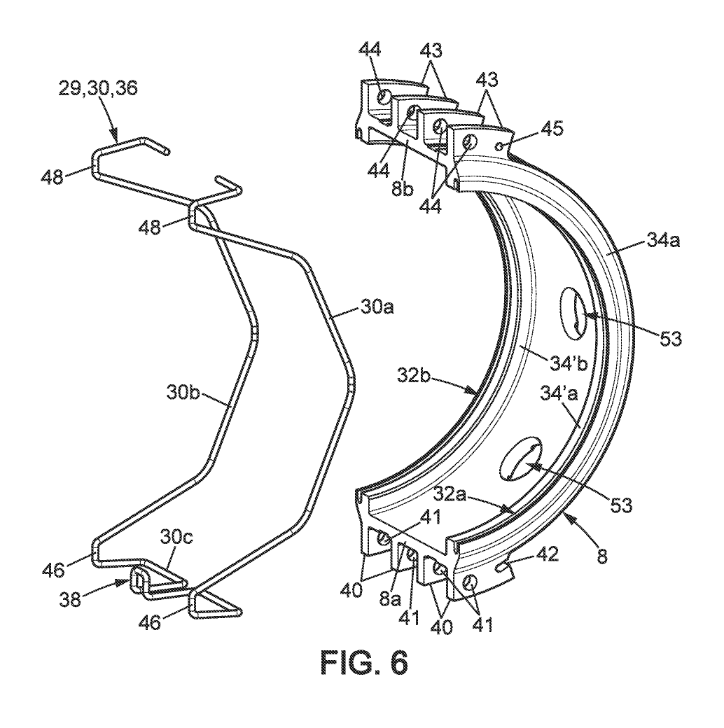

FIG. 6 is an exploded three-quarter view of a shell and a connection-pipe element of the coupling collar according to the first embodiment;

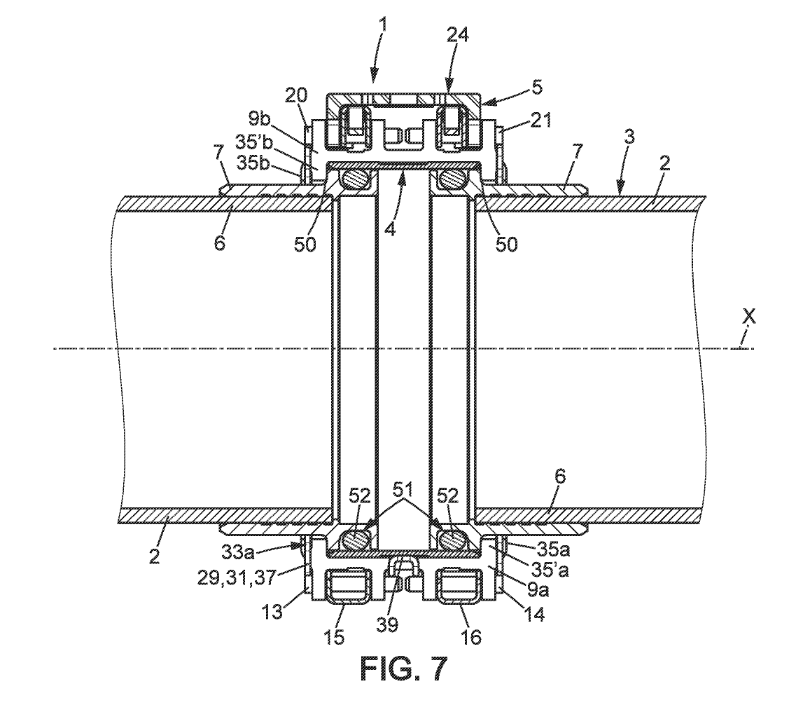

FIG. 7 is a view in cross-section of the coupling device according to the first embodiment, assembled between two pipes;

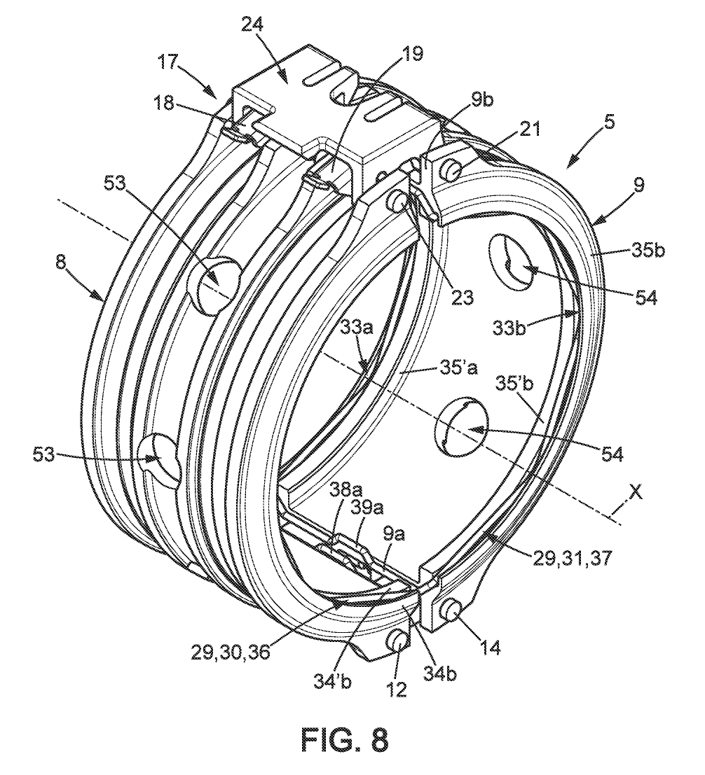

FIG. 8 is a three-dimensional three-quarter view of a coupling collar according to a second embodiment, in a closed position;

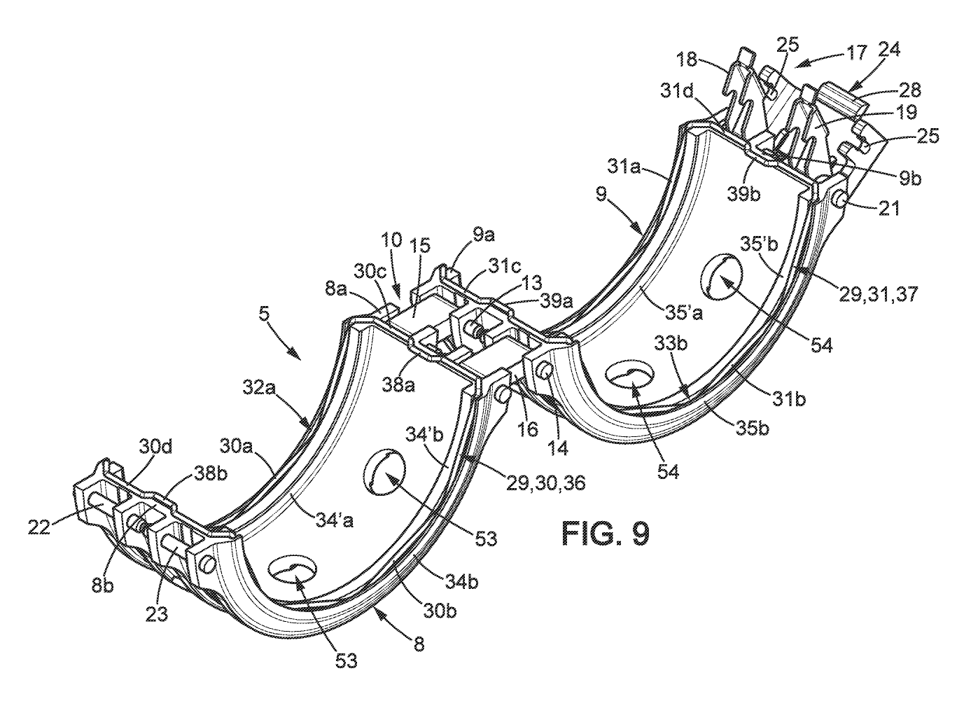

FIG. 9 is a view similar to that of FIG. 8, of the coupling collar, in an open position;

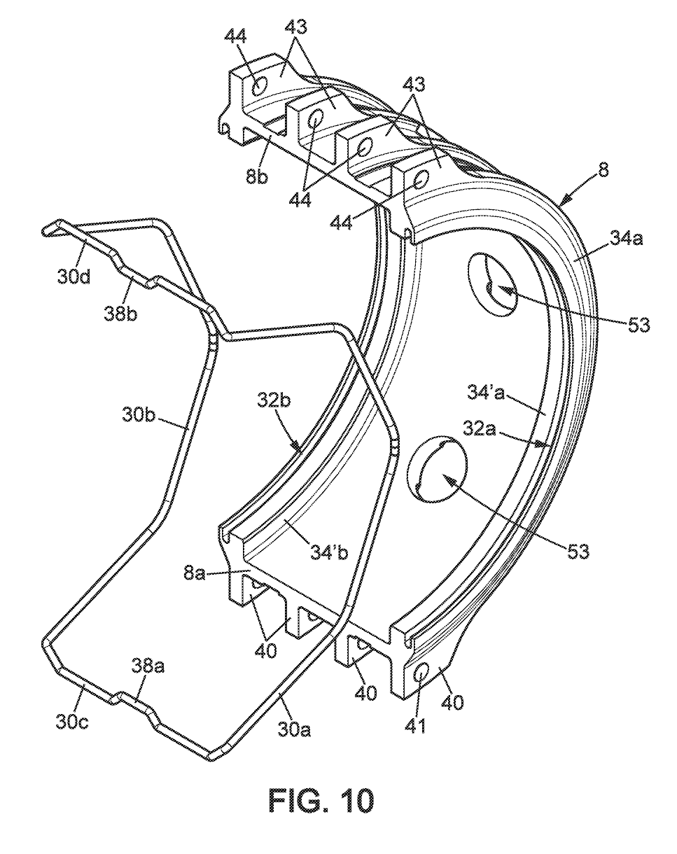

FIG. 10 is an exploded three-quarter view of a shell and a connection-pipe element of the coupling collar according to the second embodiment;

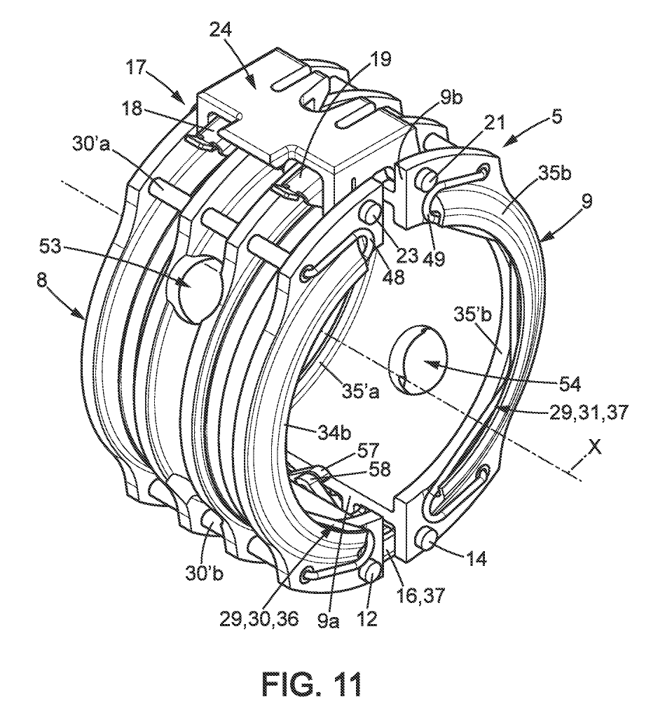

FIG. 11 is a three-dimensional three-quarter view of a coupling collar according to a third embodiment, in a closed position;

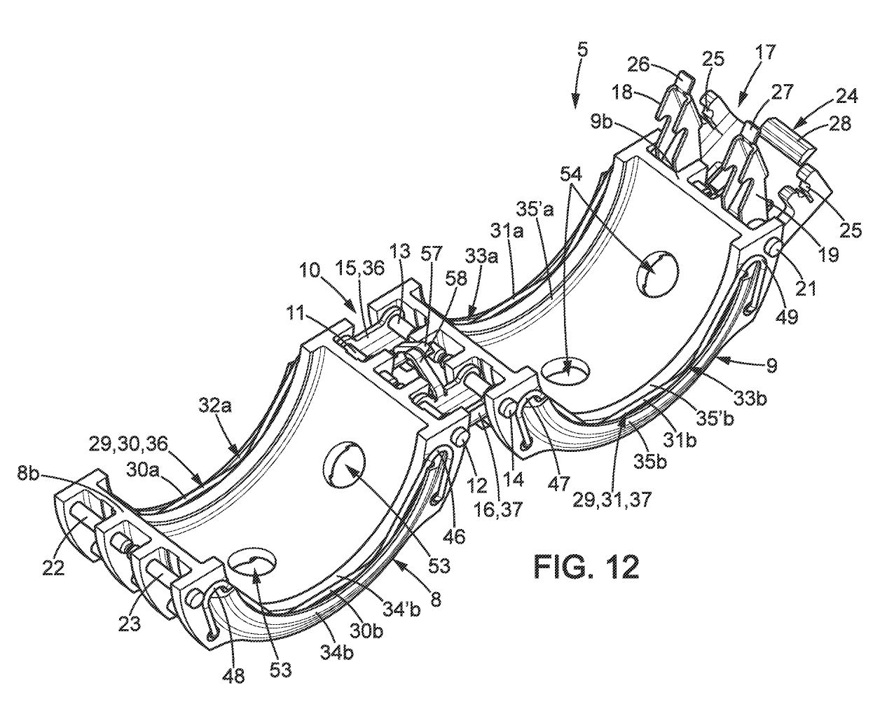

FIG. 12 is a view similar to that of FIG. 11 of the coupling collar, in an open position;

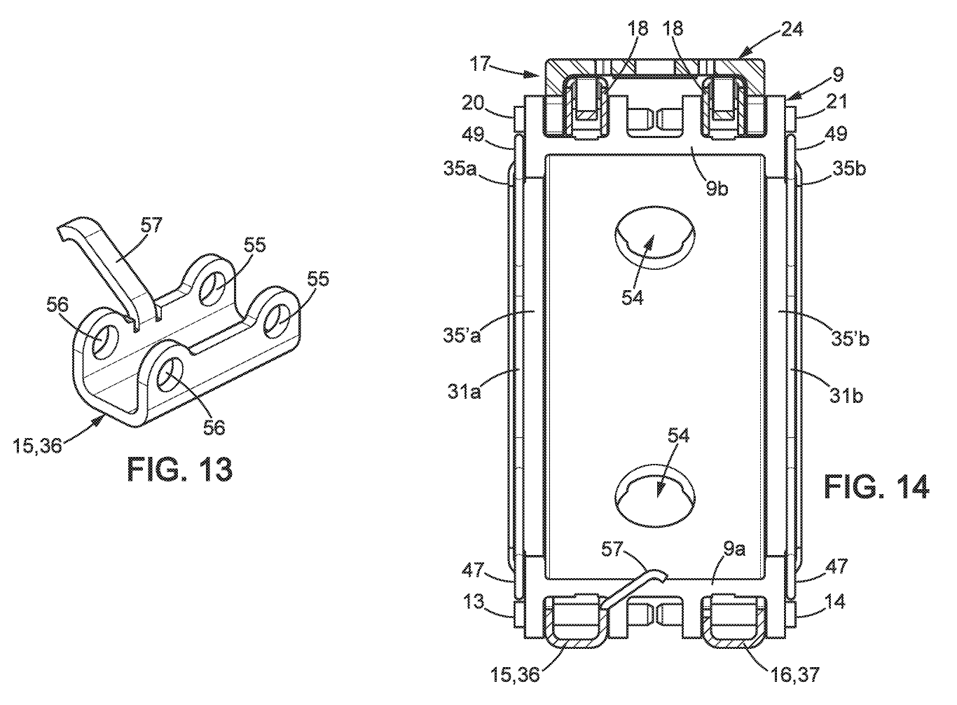

FIG. 13 is a three-quarter view of a connection-sheath element of the coupling collar according to the third embodiment;

FIG. 14 is a view in cross-section of the coupling collar according to the third embodiment, in a closed position;

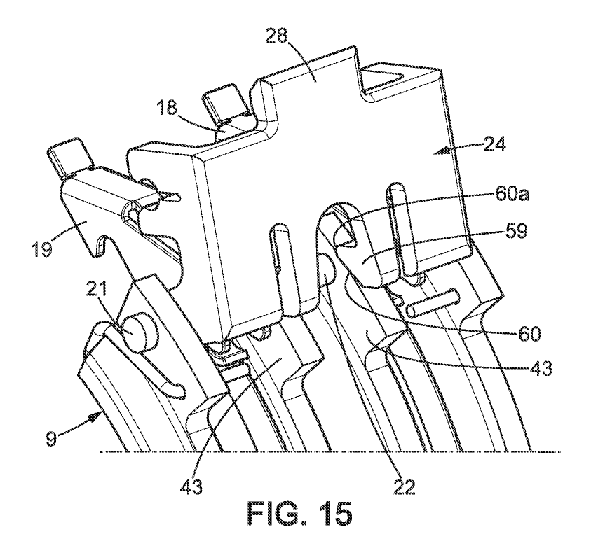

FIG. 15 is a partial view in perspective representing on an enlarged scale a device for locking a coupling collar according to the invention, the locking device being in an unlocked state;

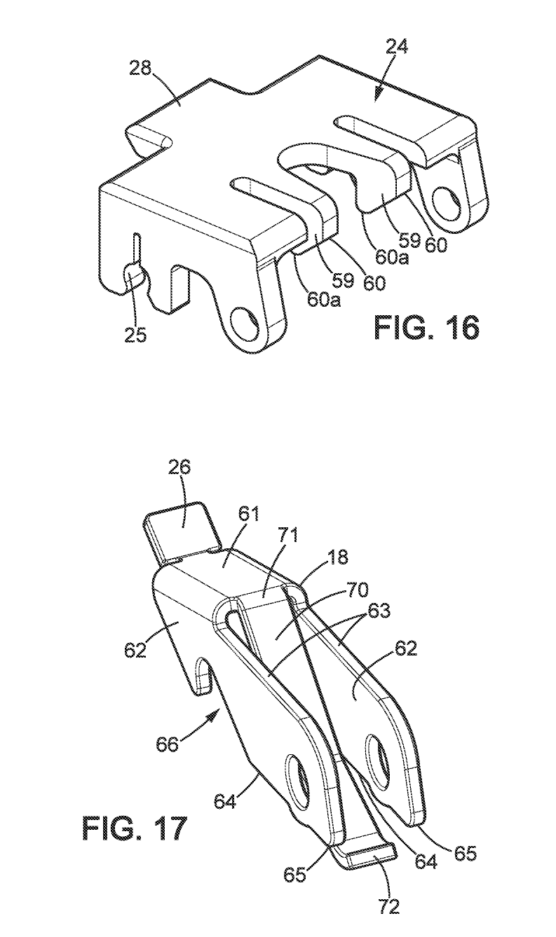

FIG. 16 is a partial view in perspective of a clasp of the coupling collar represented in FIG. 15;

FIG. 17 is a partial view in perspective of a hook of the coupling collar represented in FIG. 15;

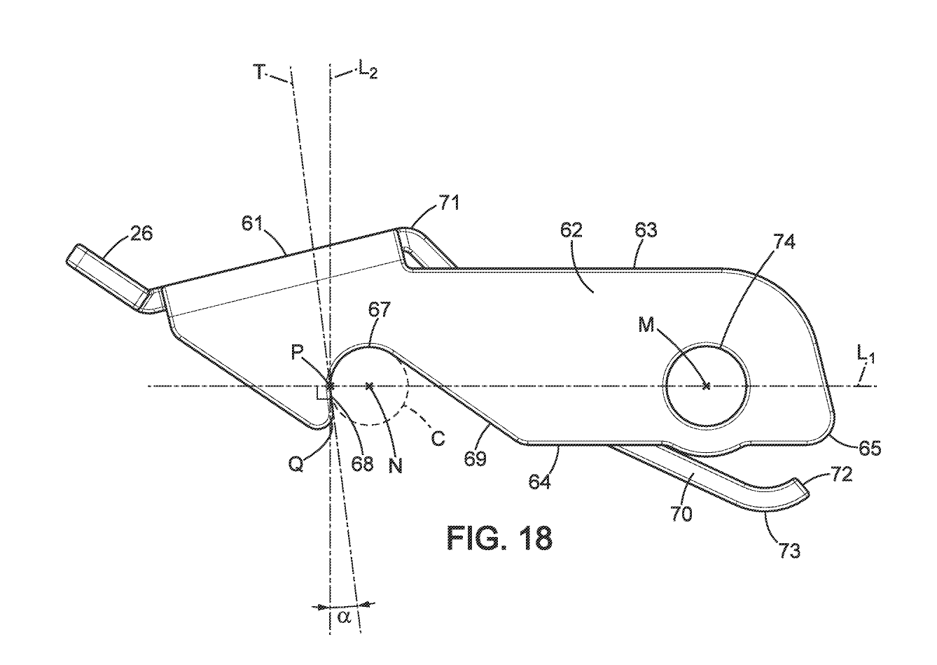

FIG. 18 is a front view of the hook represented in FIG. 17;

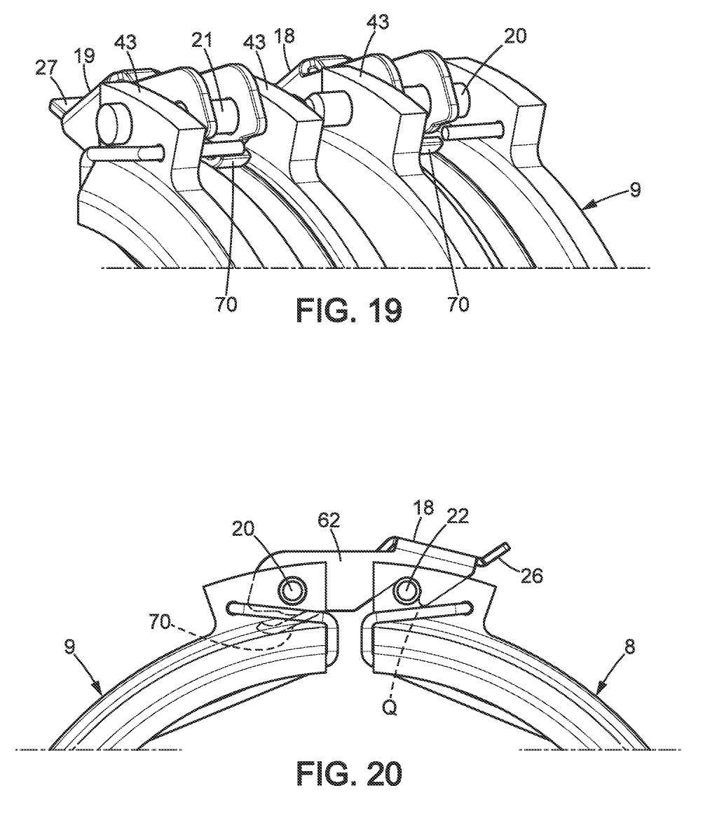

FIG. 19 is a view similar to FIG. 15, but without the clasp;

FIG. 20 is a partial view from the rear of the coupling collar represented in FIG. 15, without the clasp, the locking device being in a locked state.

For the sake of clarity, only the elements which are useful for understanding of the embodiments described have been represented, and will be described.

FIGS. 1 to 14 represent a coupling device 1 for two pipes 2 of piping 3, comprising a coupling collar 5 and advantageously sheath 4, according to three embodiments. The sheath 4 extends according to an axis of extension X, which is advantageously the axis of extension of the piping 3 at least at the coupling of the two pipes 2. For understanding of the following description, it should also be specified that the coupling collar 5 can adopt a closed position around the axis of extension X, as will be explained hereinafter.

In the continuation of the description, the adjective “inner” and its variants will designate whatever is turned towards or close to the axis of extension X. On the other hand, the adjective “outer” and its variants designate whatever is turned opposite or is spaced from the axis of extension X.

In addition, by convention, it should be stated firstly that the axial direction will refer in the continuation of the text to any direction which coincides with the axis of extension X, and secondly, that the radial direction will refer to any direction starting from the axis of extension X, and belonging to a plane perpendicular to this axis of extension X.

As far as the coupling collar 5 is concerned, she adjectives “inner” and “outer” and their variants, as well as the references to the axial and radial directions, must be interpreted taking into consideration the coupling collar 5 in the closed position.

FIGS. 1 to represent a first embodiment of the coupling device 1 according to the invention, making it possible to connect two pipes 2 together. Each pipe 2 has a free end portion 6 provided with a ferrule 7. The ferrule 7 can for example be secured by flanging oven the free end portion 6 of the corresponding pipe 2, or it can be welded or formed on the free end portion 6 of the pipe 2. In the embodiments described here, but in a non-limiting manner, the pipes 2 have a circular cross-section.

According to a particular embodiment, the sheath 4 is in the form of a substantially cylindrical hollow part, with an inner diameter designed to be fitted with contact on the ferrules 7 of the two pipes 2. The sheath 4 is made of electrically conductive material, for example of metal.

The coupling collar 5 comprises at least one first shell 8 and at least one second shell 9, which are substantially identical, and have a semicircular form complementary to one another, and advantageously complementary to the form of the sheath 4, such that the first shell 8 and the second shell 9 can cover the sheath 4 circumferentially.

The first shell 8 extends between a first end 8a and a second end 8b. Similarly, the second shell 9 extends between a first end 9a and a second end 9b. The first shell 8 and the second shell 9 are articulated relative to one another by means of an articulation device 10 which connects the first ends 8a, 9a of the first shell 8 and the second shell 9 to one another.

In the examples presented hereinafter, the coupling collar 5 comprises in a non-limiting manner two shells, respectively the first shell 8 and the second shell 9, which are thus called the first half-shell 8 and the second half-shell 9.

The articulation device 10 is for example of the hinge type, around an axis parallel to the axis of extension X. According to one embodiment, the articulation device 10 comprises a first shaft 11 and a second shaft 12, parallel to the axis of extension X, and preferably arranged in the extension of one another, which are inserted in openings in the first half-shell 8, in the vicinity of its first end 8a, on the outer surface of the first half-shell 8. Symmetrically, the articulation device 10 comprises a third shaft 13 and a fourth shaft 14, parallel to the axis of extension X, and preferably arranged in the extension of one another, which are inserted in openings in the second half-shell 9, in the vicinity of its first end 9a, on the outer surface of the second half-shell 9.

Advantageously, the first shaft 11 is opposite the third shaft 13, and a first connection hinge 15, forming a connecting rod, connects them. Similarly, the second shaft 12 is opposite the fourth shaft 14, and a second connection hinge 16, forming a connecting rod, connects them. The rotation of the first shaft 11, the second shaft 12, the third shaft 13 and the fourth shaft 14 in the openings in the half-shells 8, 9 can or cannot be permitted.

The first half-shell 8 and the second half-shell 9 are thus mobile relative to one another between two positions, by rotation around the first shaft 11, the second shaft 12, the third shaft 13 and the fourth shaft 14, i.e.:
a closed position of the coupling collar 5, in which the first half-shell 8 and the second half-shell 9 are aligned in the continuity of one another around. the axis of extension X, and in particular the second end 8b of the first half-shell 8 faces the second end 9b of the second half-shell 9, and the space between them. is minimal, the coupling collar 5 then being able to cover the sheath 4 circumferentially, in order to maintain the two pipes 2 together; and
an open position of the coupling collar 5, in which the alignment of the first half-shell 8 and the second half-shell 9 is broken, with the second end 8b of the first half-shell 8 and the second end 9b of the second half-shell 9 being spaced from one another by a space which is varied by actuating the articulation device 10.

The articulation device 10 is such. that the coupling collar 5 can adopt an open. position in which the space between the second end 8b of the first half-shell 8 and the second end 9b of the second half-shell 9 is sufficient to permit the passage of the sheath 4 between them. Use on the first half-shell 8 and respectively the second half-shell 9 of two shafts, respectively the first shaft 11 and the second shaft 12 on the one hand, and the third shaft 13 and the fourth shaft 14 on the other hand, in order to form the articulation device 10, makes it possible to increase the safety in the event of failure of one of the shafts, i.e. the first shaft 11, the second shaft 12, the third shaft 13 or the fourth shaft 14, or of the first connection hinge 15, and/or the second connection hinge 16.

The coupling collar 5 also has a locking device 17, which has:
a locked state, in which the coupling collar 5 is maintained in the closed position, the articulation. device 10 being blocked, such that the minimal space between the second end 8b of the first half-shell 8 and the second end 9b of the second half-shell 9 is maintained;
an unlocked state, in which the articulation device 10 is free, with the first half-shell 8 and the second half-shell 9 being able to pivot freely relative to one another in order to modify the space between the first half-shell 8 and the second end 9b of the second half-shell 9.

The locking device 17 comprises for example at least a first hook 18, preferably a first hook 18 and a second hook 19, which are advantageously identical, and secured on the second half-shell 9 in the vicinity of its second end 9b. More specifically, the first hook 18 and respectively the second hook 19 is articulated on the second half-shell 9 around a single shaft parallel to the axis of extension X. For this purpose, the first hook 18 is articulated around a first articulation shaft 20 inserted in an opening in the second half-shell 9 on the outer surface of the second half-shell 9, and the second hook 19 is articulated around a second articulation shaft 21, parallel to the first articulation shaft 20, advantageously in the extension of the first articulation shaft 20, inserted in an opening in the second half-shell 9 on the outer surface of the second half shell 9.

The first half-shell 8 comprises a first retention shaft 22 and a second retention shaft 23, which are advantageously parallel to the axis of extension X, and are inserted in openings in the first half-shell 8, in the vicinity of its second end 8b, on the outer surface of the first half-shell 8. The first retention shaft 22 is opposite the first articulation shaft 20, and the second retention shaft 23 is opposite the second articulation shaft 21.

When the coupling collar 5 is in the closed position, by pivoting the first hook 18 around the first articulation shaft 20, it is snapped onto the first retention shaft 22; similarly, by pivoting the second hook 19 around the second articulation shaft 21, it is snapped onto the second retention shaft 23. The locking device 17 is then in the locked state. The snapping-on force necessary is such that the locking device 17 can be locked manually. Optionally, the coupling collar 5 can additionally comprise a clasp 24 in the form of a molded plastic part articulated in rotation on the first articulation shaft 20 and the second articulation shaft 21. The clasp 24 comprises an attachment portion 25, which is advantageously resiliently deformable, and can be snapped by deformation onto the first retention shaft 22 and the second retention shaft 23. Thus, when the first hook 18 and respectively the second hook 19 is snapped onto the first retention shaft 22 and respectively the second retention shaft 23, the clasp 24 can cover it by snapping in its turn onto the first retention shaft 22 and. respectively the second retention shaft 23. The clasp 24 provides an indication of the locked state, with the first hook 18 and respectively the second hook 19 preventing the clasp 24 from snapping onto the first retention shaft 22 and respectively the second retention shaft 23 until the first hook 18 and respectively the second hook 19 has done so.

Resilient deformation here means the property of being deformed under the action of a given maximum constraint and returning to the initial form in the absence of constraint.

In order to make the locking device 17 go from the locked state to the unlocked state, an operator can raise, preferably manually, but optionally by means of a tool, the clasp 24 and the first hook 18 and respectively the second hook 19. For this purpose, the first hook 18 and respectively the second hook 19 can comprise at one end a tongue 26 and respectively a tongue 27, forming a grasping means. Similarly, the clasp 24 comprises at one end a handle 28 forming a grasping means. The tongues 26, 27 and the handle 28 thus facilitate gripping of the first hook 18 and respectively the second hook 19 and the clasp 24, manually or with a tool, in order to raise them.

The coupling collar 5 finally comprises electrical continuity means 29, in order to ensure the electrical continuity between the two pipes. For this purpose, the first half-shell 8 comprises a first connection-pipe element 30, and the second half-shell 9 comprises a second connection-pipe element 31. The first connection-pipe element 30 and respectively the second connection-pipe element 31 is for example in the form of a wire element.

The first half-shell 8 and respectively the second half-shell 9 has in its inner surface a first groove 32a and respectively a first groove 33a, and a second groove 32b and respectively a second groove 33b, extending circumferentially between the first end 8a and the second end 8b of the first half-shell 8 and the first end 9a and the second end 9b of the second half-shell 9.

More specifically, on the first half-shell 8, the first groove 32a is formed between a first axial face 34a of the first half-shell 8 and. a first lip 34′a, the second groove 32b being formed between second axial face 34b and a second lip 34′b. Similarly, on the second half-shell 9, the first groove 33a is formed between a first axial face 35a of the second half-shell 9 and a first lip 35′a, the second groove 33b being formed between a second axial face 35b and a second li 35′b.

The first connection-pipe element 30, which advantageously has a wire form, is bent in order to extend both in the first groove 32a and in the second groove 32b of the first half-shell 8. Thus, the first connection-pipe element 30 comprises a first portion 30a which extends in the first groove 32a of the first half-shell 8, a second portion 30b which extends in the second groove 32b of the first half-shell 8, and an intermediate portion. 30c which ensures the continuity between the first portion 30a and the second portion 30b of the first connection-pipe element 30. The first connection-pipe element 30 is not in contact along its entire length with the bottom of the first groove 32a and the second groove 32b.

More specifically, preferably, the first connection-pipe element 30 is bent such that it comprises segments in contact with the bottom of the first groove 32a and the second groove 32b, alternating with segments which emerge from the first groove 32a and the second groove 32b. Thus, when the coupling collar 5 is assembled on the sheath 4 and the pipes 2, the segments of the first portion 30a of the first connection-pipe element 30 emerging from. the first. groove 32a in the first half-shell 8 come into contact with the ferrule 7 of one of the pipes 2, and the segments of the second portion 30b of the first connection-pipe element 30 emerging from the second groove 32b in the first half-shell 8 come into contact with the ferrule 7 of the other one of the pipes 2.

The second connection-pipe element 31 is substantially identical to the first connection-pipe element 30, and is fitted in an identical manner on the second half-shell 9 comprising a first portion 31a, a second portion 31b, and an intermediate portion 31c which ensures the continuity between the first portion 31a and the second portion 31b of the second connection-pipe element 31.

Thus, when the coupling collar 5 is assembled on the sheath 4 and the pipes 2, segments or a first portion 31a of the second connection-pipe element 31 emerging from the first groove 33a in the second half-shell 9 come into contact with the ferrule 7 of one of the pipes, and segments of the second portion 31b of the second connection-pipe element 31 emerging from the second groove 33b in the second half-shell 9 come into contact with the ferrule 7 of the other one of the pipes 2.

The first connection-pipe element 30 and respectively the second connection-pipe element 31 can be obtained from a single continuous wire or from a plurality of portions connected to one another, in order to ensure electrical continuity.

According to the invention, when the coupling collar 5 is in the closed position, at least one space is formed between the first half-shell 8 and the second half-shell 9. Thus, a first space can be formed between the first end 8a of the first half-shell 8 and the first end 9a of the second half-shell 9, and/or a second space can be formed between the second end 8b of the first half-shell 8 and the second. end 9b of the second half-shell 9.

The first space and/or the second space are used for passage of at least one connection-sheath element 36 for the first half-shell 8 and/or the second half-shell 9.

According to the first embodiment, the first half-shell 8 and respectively the second half-shell 9 comprises a connection-sheath element 36 and respectively a connection-sheath element 37, formed by the corresponding first connection-pipe element 30 and respectively the corresponding second connection pipe element 31.

More specifically, and as can be seen in particular in FIG. 6 representing the first half-shell 8, the intermediate portion 30c of the first connection-pipe element 30 is bent in order to form a contact tab 38, which advantageously extends radially towards the axis of extension X, in particular along the first end 8a of the first half-shell 8, preferably without contact with the latter. Similarly, the intermediate portion 31c of the second connection-pipe element 31 is bent in order to form a contact tab 39 which extends radially towards the axis or extension X, in particular along the first end 9a of the second half-shell 9, but without contact with the latter. The contact tab 38 and the contact tab 39 extend opposite one another, but without contact, in order to avoid any interference.

In order to be fitted and retained on the first half-shell 8 and respectively the second half-shell 9, the first connection-pipe element 30 and respectively the second connection-pipe element 31 comprises fitting portions. For example, as illustrated more specifically in FIG. 6, the first half-shell 8 comprises, starting from its first end 8a, first ears 40, of which there are four in particular, extending on a limited angular sector of the outer surface, and advantageously parallel to one another. Each first ear 40 comprises a bore 41 for insertion of the first shaft 11 and the second shaft 12 of the articulation device 10. On the side opposite the first end 8a, each first ear 40 comprises a notch 42 forming a receptacle for the intermediate portion 30c of the first connection-pipe element 30, whilst allowing the contact tab 38 to be placed facing the first end 8a of the first half-shell 8. Preferably, the intermediate portion 30c of the first connection-pipe element 30 is placed in the notch 42 in order to be wedged there, but a slight clearance around the axial direction of the intermediate portion 30c in its receptacle is permitted.

Symmetrically, starting from its second end 8b, the first half-shell 8 comprises second ears 43, of which there are four in particular, extending on a limited angular sector of the outer surface, and advantageously parallel to one another. Each second ear 43 comprises a bore 44 for insertion of the first retention shaft 22 and the second retention shaft 23 of the locking device 17. Each second. ear 43 also comprises a hole 45, for insertion of the free terminal ends of the first connection-pipe element 30. Thus, the first portion 30a and the second portion 30b of the first connection-pipe element 30 each emerge from. the first groove 32a of the second groove 32b of the first half-shell 8 at its second end 8b, and are bent back towards the exterior of the first half-shell 8 in order to be inserted in the holes 45.

The same apples for the second half-shell 9 and the second connection-pipe element 31. Thus, preferably, the first half-shell 8 and the second half-shell 9 are substantially identical, therefore facilitating the production of the parts, their storage and their assembly.

Thus, the first connection-pipe element 30 has first return. segments 46, 48 which extend along the first axial face 34a and the second axial face 34b of the first half-shell 8. In addition, the second connection-pipe element 31 has two return segments 47, 49 which extend along the first axial face 35a and the second axial face 35b of the second half-shell 9.

The first return segments 46 of the first connection-pipe element 30 face, but without contact, the first return segments 47 of the second connection-pipe element 31. Similarly, the second return segments 48 of the first connection-pipe element 30 face, but without contact, the second return segments 49 of the second connection-pipe element 31. A minimum distance between the first return segments 46 and respectively the first return segments 48 of the first connection-pipe element 30, and the second return segments 47 and respectively the second return segments 49 of the second connection-pipe element 31 is ensured.

According to a particular embodiment, each ferrule 7 comprises a shoulder 50 which forms an increase in diameter towards the terminal end. On the shoulder 50, each ferrule 7 comprises a channel 51 which extends in its circumference, and forms a receptacle for a seal 52, for example an O-ring seal.

The coupling device 1 is assembled on the two pipes 2 as follows.

The sheath 4 is inserted on the terminal end of the ferrule 7 of a first pipe 2, such that the sheath 4 covers the ferrule 7 with circumferential contact, and more specifically covers the corresponding channel 51 and seal 52. The terminal end of the ferrule 7 of the second pipe 2 is inserted in the sheath 4, such that the sheath 4 is in circumferential contact with the ferrule 7 of the second pipe 2, and covers the corresponding channel 51 and seal 52. The contact between the seals 52 and the sheath ensures good sealing of the connection.

The coupling collar 5 in the open position is brought around. the sheath 4. The first half-shell 8 and the second half-shell 9 are articulated around the articulation device 10 in order to put the coupling collar 5 in the closed. position around the sheath 4, with the first lip 34′a of the first half-shell 8 and the first lip 35′a of the second half-shell 9 being able to be supported against the shoulder 50 of the ferrule 7 of the first pipe 2, and the second lip 34′b of the first half-shell 8 and the second lip 35′b of the second half-shell 9 being able to be supported against the shoulder 50 of the ferrule 7 of the second pipe 2. Thus, the first portion 30a of the first connection-pipe element 30 and the first portion 31a of the second connection-pipe element 31 are in contact with the ferrule 7 of the first pipe 2, and the second portion 30b of the first connection pipe element 30 and the second. portion 31b of the second connection-pipe element 31 are in contact with the ferrule 7 of the second pipe 2

The contact tabs 38, 39 are in contact against the sheath 4. Firm contact between the contact tabs 38, 39 and the sheath 4 is ensured by application of a support force by the sheath 4 on the contact tabs 38, 39. The risks of fracture of the first connection-pipe element and the second connection-pipe element 31 by this support are reduced in particular thanks to the slight clearance permitted of the intermediate portions 30c and 31c in their receptacle, and the resilience of the first connection-pipe element 30 and the second connection-pipe element 31 with a wire form.

The two pipes 2 are thus kept together, therefore ensuring the fluid continuity between them. Since each metal part is in contact with the others, the problems of continuity are virtually non-existent. In fact, the current can circulate from one pipe 2 to the other by passing via the first connection-pipe element 30 and the second connection-pipe element 31, the contact tabs 38, 39, the sheath 4 and the coupling collar 5.

No additional part has been added, with. the connection-sheath elements 36, 37 being combined with the first connection-pipe element 30 and the second connection-pipe element 31. In addition, the first half-shell 8 and respectively the second half-shell 9 can comprise at least one inspection hole 53, in particular two inspection holes 53, 54, which allow an operator to have a perfect view of the sheath 4 when the coupling collar 5 is in the closed position, this view not being impeded because the first connection-pipe element 30 and the second connection-pipe element 31 are spaced from the inspection holes 53, 54. description will now be provided of a second embodiment with reference to FIGS. 8 to 10. The second embodiment differs from the first embodiment by the form of the first connection-pipe element 30 and the second. connection-pipe element 31, and the connection-sheath elements 36, 37. Consequently, elements which are identical to the first embodiment will not be described again for the second embodiment, and are designated in FIGS. 8 to 10 by the same references.

In the same way as in the first embodiment, the first connection-pipe element 30 and the second connection-pipe element 31 are in the form of a wire element, and the connection-sheath elements 36, 37 are combined with the first connection-pipe element 30 and the second connection-pipe element 31.

More specifically, the first connection-pipe element 30 and the second connection-pipe element 31 of the second embodiment are in a wire form, and are each obtained for example by bending metal wire back on itself.

As in the first embodiment, the first connection-pipe element 30 and respectively the second connection-pipe element 31 comprises a first portion 30a and respectively a first portion 31a, designed to be in contact with the ferrule 7 of a first pipe 2, and a second portion 30b and respectively a second portion 31b, designed to be in contact with the ferrule 7 of a second pipe 2. The first connection-pipe element 30 and respectively the second connection-pipe element 31 additionally comprises two intermediate portions 30c, 30d and respectively two intermediate portions 31c, 31d connecting the first portion 30a of the first connection-pipe element 30 and the second portion 30b of the first connection-pipe element first portion 31a of the second connection-pipe element 31, connecting respectively the first portion 31a of the second connection-pipe element 31 and the second portion 31b of the second connection-pipe element 31.

In the same way as in the first embodiment, the first portion 30a of the first connection-pipe element 30 and the first portion 31a of the second connection-pipe element 31 are accommodated respectively in first grooves 32a, 33a in the inner face of the first half-shell 8 and the corresponding second half-shell 9, and the second portion 30b of the first connection-pipe element 30 and the second portion 31b of the second connection-pipe element 31 are accommodated respectively in second grooves 32b, 33b in the inner face of the first half-shell 8 and the corresponding second half-shell 9.

Each first portion 30a, 31a and each second portion 30b, 31b comprises segments emerging from the first grooves 32a, 33a and second grooves 32b, 33b, designed to come into contact with the ferrules 7 of the pipes 2. These segments are secured, for example by crimping the first lips 34′a, 35′a and the second lips 34′b, 35′b at the segments in contact with. the bottom of the first grooves 32a, 32b and the second. grooves 33a, 33b which accommodate them.

The connection-sheath elements 36, 37 are formed. by bending the intermediate portions 30c, 30d of the first connection-pipe element 30 and the intermediate portions 31c, 31d of the second connection-pipe element 31. More specifically, as illustrated in FIG. 10, a first intermediate portion 30c of the first connection-pipe element 30 is bent in order to form a first tongue 38a preferably extending radially towards the axis of extension X, and a second intermediate portion 30d of the first connection-pipe element 30 is bent in order to form a second tongue 38b also preferably extending radially towards the axis of extension X. The same applies to the second half-shell 9 and the second connection-pipe element 31, i.e. a first intermediate portion 31c of the second connection--pipe element 31 is bent in order to form a third tongue 39a preferably extending radially towards the axis of extension X, and the second intermediate portion 31d of the second connection-pipe element 31 is bent in order to form a fourth tongue 39b preferably also extending radially towards the axis of extension X.

The first tongue 38a extends facing the first end 8a of the first half-shell 8, advantageously spaced from the latter, and the second tongue 38b extends facing the second end 8b of the first half-shell 8, advantageously spaced from the latter. The third tongue 39a extends facing the first end 9a of the second half-shell 9, advantageously spaced from the latter, and the fourth tongue 39b extends facing the second end 9b of the second half-shell 9, advantageously spaced from the latter.

When the coupling collar 5 is in the closed position, the first tongue 38a and the third tongue 39a extend in the first space, between the end 8a of the first half-shell 8 and the first end 9a of the second half-shell 9, without contact with one another. The second tongue 38b and the fourth tongue 39b extend in the second space, between the second end 8b of the first half-shell 8 and the second end 9b of the second half-shell 9, without contact with one another.

According to the second embodiment, the radial extension of the first tongue 38a, the second tongue 38b, the third tongue 39a and the fourth tongue 39b is such that, during the assembly of the coupling device 1 on the two pipes 2, they come into contact on the sheath 4.

According to the second embodiment, the first connection-pipe element 30 and the second connection-pipe element 31 are located entirely on the lower face of the first half-shell 8 and the second half-shell 9, such that they do not have a return portion as in the first embodiment. The risks of interference between the first connection-pipe element 30 and the second connection-pipe element 31 are thus reduced.

A description will now be provided of a third embodiment with reference to FIGS. 11 to 14. The third embodiment differs from the first embodiment and the second embodiment in that the connection-sheath elements 36, 37 are not combined with the first connection-pipe element 30 and the second connection-pipe element 31. Consequently, the elements which are identical to the first embodiment will not be described again for the third embodiment, and are designated in FIGS. 11 to 14 by the same references.

Thus, contrary to the first embodiment and the second embodiment, the first connection-pipe element 30 and the second connection-pipe element 31 do not comprise contact tabs 38, 39 or tongues.

More specifically, the first connection-pipe element 30 and respectively the second connection-pipe element 31 are in the form of a wire element formed by two metal wires, the two ends of which are joined by means of tubes.

For example, as shown in FIG. 11, the two wires of the first connection-pipe element 30 are joined at their ends by crimping in two tubes 30′a, 30′b. The two wires of the second connection-pipe element 31 are joined similarly at their ends by crimping in two other tubes. The four tubes are each retained on the exterior of the first half-shell 8 and the second half-shell 9 by inserting them in axial bores.

Other embodiments of the first connection-pipe element 30 and the second connection-pipe element 31 can be envisaged. For example, the first connection-pipe element 30 and respectively the second connection-pipe element 31 can be a single wire which is bent back and retained on the first half-shell 8 and respectively the corresponding second half-shell 9, in a manner similar to the examples given in the first embodiment and the second embodiment.

According to the third embodiment, two connection-sheath elements 36, 37 are formed on the first connection hinge 15 and. the second connection hinge 16 of the first shaft 11, the second shaft 12, the third shaft 13 and the fourth shaft 14 of the articulation device 10. More specifically, the first connection hinge 15 forms a first connection-sheath element 36, and the second connection hinge 16 forms a second connection-sheath element 37.

FIG. 13 represents the first connection hinge 15. The first connection hinge 15 comprises a fitting portion provided with two first openings 55 for insertion of the first shaft 11 of the articulation device 10, and two second openings 56 for insertion of the third shaft 13 of the articulation device 10. The first connection. hinge 15 also comprises a contact tab 57, which advantageously extends radially towards the axis of extension X. Preferably, the contact tab 57 is closer to the second openings 56 than. to the first openings 55.

Similarly, the second connection hinge 16 also comprises a contact tab 58, which. advantageously extends radially towards the axis of extension X.

Preferably, the contact tab 58 is closer to the openings in the second connection hinge 16 designed for the insertion of the second shaft 12 than to the openings which are designed for the insertion of the fourth shaft 14 of the articulation device 10.

According to the third embodiment, the first shaft 11, the second shaft 12, the third shaft 13 and the fourth shaft 14 of the articulation. device 10 can be fitted clamped in openings in the first connection hinge 15 and/or the second connection hinge 16. However, preferably, and as will be explained hereinafter, in order to limit the risks of galvanic corrosion, the first shaft 11, the second shaft 12, the third shaft 13 and the fourth shaft 14 of the articulation device 10 are crimped in their center after being fitted in order to prevent them from coming out of the openings in. the first connection hinge 15 and/or the second connection hinge 16.

Thus, when the coupling device 1 is in the closed position, the contact tabs 57, 58 extend in the first space between the first end 8a of the first half shell and the first end 9a of the second half-shell 9, without contact with one another.

According to the third embodiment, in order to reduce the risks of interference between the first connection-pipe element 30 and the second connection-pipe element 31, the first return segments 46, 48 of the first connection-pipe element 30 are at a greater distance from the two return segments 47, 49 of the second connection-pipe element 31 than in the first embodiment. For this purpose, the first groove 32a and the second groove 32b of the first half-shell 8 do not extend as far as the first end 8a and the second end 8b of the first half shell 8. Similarly, the first groove 33a and the second groove 33b of the second half-shell 9 do not extend as far as the first 9a and the second end 9b of the second half-shell 9.

When the coupling collar 5 is assembled in the closed position on the sheath 4 and the two pipes 2, the contact tabs 57, 58 are supported on the sheath 4. The contact. tabs 57, 58 can be slightly flexible, i.e. they can be deformed without breaking under the support force applied by the sheath 4, and resume their initial position in the absence of support on the sheath 4.

The coupling device 1 thus described uses the components already present in the coupling collar 5, i.e. either the first connection-pipe element 30 and the second connection-pipe element 31, or the first connection. hinge 15 and the second connection hinge 16 of the articulation device 10, in order to form connection-sheath elements 36, 37, such that there is no additional part. The costs of production of the coupling device 1 are thus reduced in comparison with the solutions according to the prior art which use an additional part in order to obtain an electrical connection on the sheath 4.

In addition, the connection-sheath elements 36, 37 extend in the first space between the first ends 8a, 9a and/or in the second space between the second ends 8b, 9b of the first half-shell 8 and the second half-shell 9, such that the size of the coupling device 1 is not increased.

For each embodiment, an example has been given of implementation of the first connection-pipe element 30 and the second connection-pipe element 31. These examples are in no way limiting. Thus, each of these examples for one embodiment can be adapted for another embodiment. Any variant of these examples can also be adapted to each of the embodiments.

In order to ensure the electrical continuity whilst protecting against corrosion, the surface of the first half-shell 8 and/or of the second half-shell 9 is treated such that:
the bottom. of the first grooves 32a, 33a and the second grooves 32b, 33b which partly accommodate the first connection-pipe element 30 and/or the second connection-pipe element 31 is covered with a layer which protects against galvanic corrosion and ensures the electrical continuity with the first connection-pipe element 30 and/or the second connection-pipe element 31;
the bores 41, 44 in which there are inserted the first shaft 11, the second shaft 12, the third shaft 13 and the fourth shaft 14 of the articulation device 10, and the first articulation shaft 20, the second articulation shaft 21, the first retention shaft 22 and the second retention shaft 23 of the locking device 17, are covered with a layer which protects against galvanic corrosion and ensures the electrical continuity with the first shaft 11, the second shaft 12, the third shaft 13 and the fourth shaft 14, the first articulation shaft 20, the second articulation shaft 21, the first retention shaft 22 and the second retention shaft 23;
the other surfaces of the first half-shell 8 and/or of the second half-shell 9 are covered with a layer which protects them against galvanic corrosion, but makes them. electrically neutral.

In addition, the first shaft 11, the second shaft 12, the third shaft 13 and the fourth shaft 14 of the articulation device 10, and the first articulation shaft 20, the second articulation shaft 21, the first retention shaft 22 and the second retention shaft 23 of the locking device 17 are preferably fitted with play in the corresponding bores in the first half-shell 8 and/or the second half-shell 9, in order to prevent loss of the protective coating. The first shaft 11, the second. shaft 12, the third shaft 13 and the fourth. shaft 14 of the articulation device 10, and the first articulation shaft 20, the second articulation shaft 21, the first retention shaft 22 and the second retention shaft 23 of the locking device 17 are then advantageously crimped in their center in order to prevent them from coming out of the bores.

In relation with FIGS. 15 to 20, a description will now be provided of a particular embodiment of the locking device 17 which can be adapted to any type of coupling collar 5, and provides increased safety.

As previously described, the locking device 17 comprises the first hook 18, preferably the first hook 18 and the second hook 19, and the first articulation shaft 20, preferably the first articulation shaft 20 and the second articulation shaft 21, and the first retention shaft 22, preferably the first retention shaft 22 and the second retention shaft 23.

In order to prevent the clasp 24 from closing by snapping of its attachment portion 25 on the first retention shaft 22 and the second retention shaft 23 whereas the first hook 18 and the second hook 19 are not engaged on the first retention shaft 22 and the second retention shaft 23, the clasp 24 comprises at least one return tab 59, preferably two return tabs 59, which are designed to cooperate with the second ears 43 of the second half-shell 9.

In fact, the second ears 43 form radial projections on the outer surface of the second half-shell 9 which extend angularly from its second end 9b. The return tabs 59 of the clasp 24 are such that, when the clasp 24 is fitted on the first articulation shaft 20 and the second articulation shaft 21, each return tab 59 is in contact with one of the second ears 43. For this purpose, the return tabs 59 have an inclined surface 60 which forms a ramp, and a terminal end 60a, which is preferably rounded.

In the absence of exterior action, the clasp 24 can adopt only two positions, i.e.:
an initial open position, in which the attachment portion 25 of the clasp 24 is not snapped onto the first retention shaft 22 and the second retention shaft 23;
a closed position, in which the attachment portion 25 of the clasp 24 is snapped onto the first retention shaft 22 and the second retention shaft 23.

The return tabs 59 act in the manner of a spring, and thrust the clasp 24 to the open position. The clasp 24 can go from the initial open position to the closed position only by means of an exterior action, for example by an. operator, by pivoting the clasp 24 onto the first articulation shaft 20 and the second articulation shaft 21, against the thrust of the return tabs 59. For as long as the clasp 24 is not retained in the closed position by snapping onto the first retention shaft 22 and the second retention shaft 23, and in the absence of exterior action, the return tabs 59 return the clasp 24 to the initial open position.

More specifically, the contact between the inclined surface 60 of the return tabs 59 and the second ears 43 retains the clasp 24 in the open position. The form of the inclined surface 60 means that the force applied on the clasp 24 to make it pivot towards its closure increases as the rotation takes place. Thus, in order to be able to bring the attachment portion onto the first retention shaft 22 and the second. retention shaft 23 by pivoting the clasp 24 on the first articulation shaft 20 and the second articulation shaft 21, the operator must apply a force on the clasp 24 in order to overcome the resistance generated by the contact between the return tabs 59 and the second ears 43, until the terminal end 60a is in forced contact with the second ears 43, and the attachment portion 25 snaps onto the first retention shaft 22 and the second retention shaft 23. Resilient deformation of the clasp 24 under the action of the operator can facilitate the closure. If the snapping onto the first retention shaft 22 and the second retention shaft 23 does not take place, when the operator releases she clasp 24, she clasp 24 returns automatically to the initial open position under the action. of the return tabs 59.

However, the operator can apply this force only if the first hook 18 and the second hook 19 have previously been closed by snapping onto the first retention shaft and the second retention shaft 23, i.e. when the locking device 17 is locked.

In the closed position of the clasp 24, the terminal end 60a of the return tabs 59 remain in contact with the second ears 43, such that, when the clasp 24 is no longer snapped onto the first retention shaft 22 and the second. retention shaft 23, the constraint exerted by the contact between the terminal ends 60a and the second ears 43 is released, and returns the clasp 24 to its initial open position.

The clasp 24 thus provides a “flag” function thanks to the resilient return of the return tabs 59: it indicates whether the first hook 18 and the second hook 19 are correctly snapped on or not. When at least the first hook 18 and/or the second hook 19 is/are not snapped on, the return tabs 59 ensure the automatic return of the clasp 24 to the initial open position. The return tabs 59 are also designed such that, in order for the clasp 24 to go from the closed position to the initial open position and conversely, the clasp must be pivoted by an angle with a predetermined value, such that the operator can not visually confuse the closed position and the initial open position.

Preferably, the clasp 24 and the return tabs 59 are in a single piece, and are obtained for example by molding a plastic material.

A description will now be provided of an embodiment of the first hook 18 and respectively of the second hook 19 of the locking device 17, the first hook 18 and. the second. hook 19 preferably being identical.

The first hook 18 and respectively the second hook 19 are in the form of a single piece, in particular with a transverse cross-section in the form of a “U” on at least one portion of its length, such as to have an upper wall 61 and two lateral walls 62. The tongue 26 and respectively the tongue 27 of the first hook 18 and respectively the second hook 19, previously described, extends at a first end from the upper wall 61, in the direction opposite that in which the lateral walls 62 extend. The upper wall 61 does not extend along the entire length of the first hook 18 and respectively the second hook 19, leaving an area which extends as far as the second end of the first hook 18 and respectively the second hook 19, in which the lateral walls 62 are not connected to one another, such as each to have a free upper edge 63 and lower edge 64, which are preferably substantially parallel. At the second end, opposite the tongue 26 and respectively the tongue 27, the lower edge 64 of the lateral walls 62 is advantageously rounded such as to form a stop 65.

The lateral wall 62 also has a notch 66, which is open on the lower edge 64. The notch 66 is defined by its contour with a bottom 67, which in particular is rounded, and advantageously has a diameter substantially equal to that of the first articulation. shaft 20, and a first edge 68, known as the proximal edge 68, and a second edge 69, known as the distal edge 69, with reference to the first end of the first hook 18 and respectively the second hook 19. The first edge 68 and the second edge 69 of the notch 66 are spaced from one another starting from the bottom 67. The distance between the first edge 68 and the second edge 69 is always greater than the diameter of the first articulation shaft 20. Advantageously, the bottom 67 of the notch 66 in the lateral wall 62 is substantially coaxial with the bottom 67 of the notch 66 in the other lateral wall 62.

The first hook 18 and respectively the second hook 19 can also comprise a spring blade 70, preferably formed in the material of the first hook 18 and respectively the second hook 19, for example by cutting and bending a metal strip. The spring blade 70 is thus not an additional part, but is in a single piece with the first hook 18 and respectively the second hook 19.

The spring blade 70 comprises a first end 71 which is connected to the upper wall 61, and extends as far as a second end 72, known as the free end 72, in the direction of the second end of the first hook 18 and respectively the second hook 19, and towards the lower edge 64 of the lateral wall 62. Specifically, the second end 72 forms support area 73, which in particular is rounded.

The spring blade 70 is resiliently deformable by bending at its first end 71, for example. In the position of rest, i.e. in the absence of any constraint, at least one portion, in this case the support area 73, of the spring blade 70, extends beyond the lower edge 64 of the lateral wall 62.

Finally, the lateral walls 62 each comprise an opening 74, which is preferably circular. The two openings 74 are substantially coaxial, such as to be able to insert in them a rotational shaft, in this case the first articulation shaft 20 and respectively the second articulation shaft 21, with play which is just sufficient to permit the rotation of the first hook 18 and respectively the second hook 19, on the first articulation shaft 20 and respectively the second articulation shaft 21.

The spring blade 70 makes it possible to constrain the first hook 18 and respectively the second hook 19 in a single given stable position. More specifically, when the first hook 18 and respectively the second hook 19 is fitted on the first articulation shaft 20 and respectively the second articulation shaft 21, the support area 73 of the spring blade 70 is supported on the outer surface of the second half-shell 9, for example between two second ears 43. In order to space the first hook 18 and respectively the second hook 19 from its stable position, the operator must apply a force against the force applied by the spring blade 70, such as to obtain the rotation of the first hook 18 and respectively the second hook 19, around. the first articulation shaft 20 and respectively the second articulation shaft 21.

This force tends to deform the spring blade 70, in particular by bending at the first end 71, thus increasing progressively the force provided by the spring blade 70. Before the spring blade 70 reaches its breaking point, the stop 65 on. the lateral walls 62 comes into contact with the outer surface of the second half-shell 9, thus preventing the operator from continuing the movement.

The spring blade 70 also acts as a stop for the hook 18, 19 in the stable position, i.e. in the absence of an additional constraint, the first hook 18 and respectively the second hook 19 is naturally in its stable position.

For this purpose, the first hook 18 is considered to be articulated on the first articulation shaft 20 in order to snap onto the first retention shaft 22, on the understanding that the second hook 19, articulated on the second articulation shaft 21 in order to snap onto the second retention shaft 23, functions in the same way.

The spring blade 70 facilitates the fastening by snapping of the first hook 1$ on the first retention shaft 22, by limiting the manipulations of the first hook 18: the spring blade 70 prevents the first hook 18 from going beyond its stable position, which would make the notches 66 pass below the first retention shaft 22.

In order to snap the first hook 18 onto the first retention shaft 22 and lock the locking device 17, the operator must therefore close the first shell 8 and the second shell 9. Under the effect of the spring blade 70, the notches 66 automatically go into position on the first retention shaft 22 by sliding on the latter. Preferably, the stable position does not correspond quite to the position of snapping onto the first retention shaft 22, such that the spring blade 70 exerts a constraint on the first articulation shaft 20 if the snapping on takes place.

If the snapping on does not take place, the first hook 18 goes into its stable position, without however passing below the first retention shaft 22, which could wedge the locking device 17.

In addition, the first edge 68 and the second edge 69 of the notch 66 are especially designed to facilitate the putting into position of the first hook 18 on the first retention shaft 22.

For this purpose, when the first hook 18 and respectively the second hook 19 is seen on a plane parallel to the lateral walls 62, a first direction L1 is defined as passing via a center M of the openings 74 and via a center N of the notches 66. More specifically, the center N of the notches 66 corresponds to the center of a circle C, represented in broken lines in FIG. 18, passing via the bottom 67 of the notches 66. In other words, in the locked position of the locking device 17, the center M of the openings 74 corresponds substantially to the center of the first articulation shaft 20 and of the second articulation shaft 21, and the center N corresponds substantially to the center of the first retention shaft 22 and the second retention shaft 23.

The first direction L1 intersects the distal edge 68 at a point P, known as the point of tangency P. A second direction L2 is then defined, perpendicular to the first direction L1, and a third direction T, tangent to the circle C at the point of tangency P. The tangent T forms with the second direction L2 an angle α, with a value of between 5 and 10°, and preferably equal to 7°.

The proximal edge 68 of the notches 66 follows the tangent T starting from the point of tangency P, as far as point of contact Q on the lateral wall 62.

The value of the angle α thus determined has the advantage in particular of forcing the closure of the first hook 18 and respectively the second hook 19, giving rise to a traction force, whilst not impeding the closure.

For the purposes of explanation, the first hook 18 is considered once more, on the understanding that, in this case also, the second hook 19 functions identically. Thus, when the first hook 18 is pivoted around the first articulation shaft 20, in order to he fastened on the first retention shaft 22, the point of contact Q of the notches 66 comes into contact on the first retention shaft 22, and as a result of the angle α, a force must be applied on the first articulation shaft 20 and/or on the first. retention shaft 22 in order to bring them towards one another, such that the first retention shaft 22 goes beyond the point of contact Q, and reaches the bottom 67 of the notches 66, thus ensuring the snapping of the first hook 18 onto the first retention shaft 22 and locking of the locking device 17.

The inclination of the proximal edge 68 also ensures that the first retention shaft 22 remains in the notch 66, since an additional force must be applied in order to bring the first articulation shaft 20 towards the first retention shaft 22, such that the first retention shaft 22 goes beyond the point of contact Q, and comes out of the notch 66.

The first hook 18 and the second hook 19 thus formed, each in a single piece, then ensure firm snapping on, and prevent the locking device 17 from being wedged. The safety of locking by the locking device 17 is then increased.

It will be appreciated that the invention is not limited to the embodiments previously described and provided by way of example. It incorporates various modifications, alternative forms and other variants which persons skilled in the art could envisage within the context of the present invention, and in particular all combinations of the different operating modes previously described, which can be taken separately or in association.

1. A coupling collar to couple two pipes (2) in a sealed manner, comprising:
at least one first shell and at least one second shell, each with a first end and a second end;
at least one connection-pipe element in contact with at least one of the shells, and comprising at least one first portion which is designed to be in electrical contact with one of the pipes when the coupling collar is in the closed position, and at least one second portion which is connected electrically to the first portion, and is designed to be in electrical contact with the other one of the pipes when the coupling collar is in the closed position, characterized in that the first shell and/or the second shell comprise(s) at least one connection-sheath element comprising at least one contact tab which extends in at least one space provided between the first ends and/or the second ends of the first shell and the second shell, when the coupling collar is in the closed position.

2. The coupling collar as claimed in claim 1, characterized in that it comprises at least one contact tab which extends in the space between the first ends of the first shell and the second shell, and at least one contact tab which extends in the space between the second ends of the first shell and the second shell.

3. The coupling collar as claimed in claim 1, characterized in that the connection-pipe element is in the form of a wire element in contact with an inner face of the first shell and/or the second shell, and comprises at least one intermediate portion connecting the first portion and the second portion electrically.

4. The coupling collar as claimed in claim 3, characterized in that the connection-sheath element is formed by the intermediate portion of the connection-pipe element, the intermediate portion being bent in order to form at least the contact tab.

5. The coupling collar as claimed in claim 3, characterized in that the connection-pipe element comprises two intermediate portions, each intermediate portion being bent in order to form at least one first tongue which extends in the space between the first ends of the first shell and of the second shell, and at least one second tongue which extends in the space between the second ends of the first shell and the second shell, when the coupling collar is in the closed position.

6. The coupling collar as claimed in claim 1, characterized in that it comprises an articulation device comprising at least one shaft on the first shell and at least one shaft on the second shell, at least one connection hinge connecting the shaft of the first shell and the shaft of the second shell.

7. The coupling collar as claimed in claim 6, characterized in that the connection hinge comprises the contact tab which extends in the space between the first end of the first shell and the first end of the second shell.

8. The coupling collar as claimed in claim 6, characterized in that the articulation device comprises a first shaft and a second shaft on the first shell, and a third shaft and a fourth shaft on the second shell.

9. The coupling collar as claimed in any one of the preceding claim 1, characterized in that the first shell and/or the second shell is/are provided with at least one inspection opening which is completely clear.

10. The coupling collar as claimed in any one of the preceding claim 1, characterized in that at least one of the surfaces of the first shell and/or the second shell is/are electrically conductive.

11. The coupling collar as claimed in claim 1, characterized in that it comprises a locking device which can be released, with:
a. a locked state, in which the coupling collar is maintained in the closed position;
b. an unlocked state, in which the first shell and the second shell can pivot freely relative to one another.

12. The coupling collar as claimed in claim 11, additionally comprising a clasp which is articulated on the first shell or the second shell, the clasp comprising an attachment portion and at least one return tab, the clasp being able to adopt two positions:
an initial open position, in which the attachment portion is spaced from the first shell and respectively from the second shell;
a closed position, in which the attachment position is fastened on the second shell and the first shell respectively, characterized in that the clasp can be in the closed position only when the locking device is in the locked state, and in that the return tab cooperates resiliently with the first shell or the second shell in order to apply a force on the clasp which tends to return it to the initial open position.

13. The coupling collar as claimed in claim 12, characterized in that the clasp goes from the closed position to the open position, and conversely, by rotation on the first shell or the second shell by an angle with a predetermined value.

14. The coupling collar as claimed in claim 11, characterized in that the locking device comprises at least one first hook articulated on the first shell or the second shell, the first hook having at least one spring blade which cooperates with the first shell or the second shell, and exerts a permanent constraint on the first hook which tends to retain it in a given stable position.

15. The coupling collar as claimed in claim 11, characterized in that the locking device comprises at least one hook articulated on the first shell or the second shell respectively, the first hook comprising at least one opening for rotation around a first axis of articulation, the opening defining a first center, the first hook also comprising at least one notch for snapping onto at least the second shell or the first shell respectively.

16. The coupling collar as claimed in claim 15, characterized in that the notch has a bottom which defines a second center, a first direction being defined as passing via the first center and the second center, and a second direction being defined as being perpendicular to the first direction, the notch also having a proximal edge in a third direction which is inclined relative to the second direction.

17. The coupling collar as claimed in claim 16, characterized in that the third direction is inclined relative to the second direction by an angle of between 5° and 10°, and which is preferably equal to 7°.

18. A coupling device in order to couple two pipes in a sealed manner, comprising a sheath and a coupling collar as claimed in claim 1.

19. The coupling device as claimed in claim 18, characterized in that the contact tab is in electrical contact on the sheath when the coupling collar is in the closed position.

20. A piping designed to ensure the transport of a fluid comprising at least two pipes and a coupling device as claimed in claim 18 for coupling the pipes in a sealed manner.
